(19) United States
(12) Patent Application Publication
(10) Pub. No.: US 2009/0121676 A1
(43) Pub. Date: May 14, 2009

(54) Charging System for Enhancing Convenience

(76) Inventors: Hsi-Chang Wu, Yun-Lin County (TW); Pei-Wen Sun, Hsinchu County (TW); Yu-Shiang Lu, Chiayi County (TW); Richard Lin, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/014,100

(22) Filed: Jan. 15, 2008

(30) Foreign Application Priority Data
Nov. 8, 2007 (TW) 096142209

(51) Int. Cl. H02J 7/12

(52) U.S. Cl. 320/108; 340/10.1

(57) ABSTRACT

A charging system for enhancing convenience includes a charging device for generating an electromagnetic wave signal, and a rechargeable device installed in a portable electronic device for receiving the electromagnetic wave signal through electromagnetic induction, so as to perform recharging.

### BACKGROUND OF THE INVENTION

1. Field of the Invention

The present invention is related to a charging system for enhancing convenience, and more particularly to a charging system for effectively enhancing convenience, avoiding the durability problem because of insertion and extraction, and overcoming the charging limitation (one to one) at the same time.

2. Description of the Prior Art

Portable electronic devices such as mobile phones and personal digital assistants (PDAs) have become essential electronic products because of lightweight and small volume. Generally speaking, rechargeable batteries are utilized in the portable electronic devices as power sources for enhancing convenience such that the rechargeable batteries can be charged through a charging device.

Please refer to FIG. 1. FIG. 1 illustrates a charging schematic diagram of a prior art portable electronic device 100. When a rechargeable battery (not shown in FIG. 1) of the portable electronic device100 is to be charged, a user can insert a transforming charging device 102 into a power source outlet 104, and insert a charging plug 108 of the transforming charging device 102 into a charging outlet 106 of the portable electronic device 100. Then, the transforming charging device 102 transforms the alternating current (AC) of the power source outlet 104 into predefined direct current (DC) for charging the rechargeable battery of the portable electronic device 100.

Via insertion of the charging plug 108, the transforming charging device 102 can transfers DC power to the rechargeable battery of the portable electronic device 100. However, such charging way, inserting the charging plug 108 into the charging outlet 106, not only causes the inconvenience but also results in the imperfect contact after multiple insertions and extractions. As a result, the charging plug 108 cannot be exactly inserted into the charging outlet 106, causing charging failure. Besides, each charging device is utilized for a single portable electronic device at one time. That is, different charging outlets are utilized for different portable electronic devices. Therefore, it is inconvenient for a user having many kinds of portable electronic devices.

In short, the contact charging method in the prior art lacks using convenience, may cause the durability issue, and is limited to the one-to-one charging requirement.

### SUMMARY OF THE INVENTION

It is therefore of a primary objective of the claimed invention to provide a charging system for enhancing convenience.

The present invention discloses a charging system for enhancing convenience, which comprises a charging device for generating an electromagnetic wave signal, and a rechargeable device installed in a portable electronic device for receiving the electromagnetic wave signal through electromagnetic induction.

The present invention discloses a charging system for enhancing convenience, which comprises a charging device for generating an electromagnetic wave signal, a plurality of portable electronic devices, and each portable electronic device comprises a rechargeable device for receiving the electromagnetic wave signal through electromagnetic induction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a charging schematic diagram of a prior art portable electronic device.

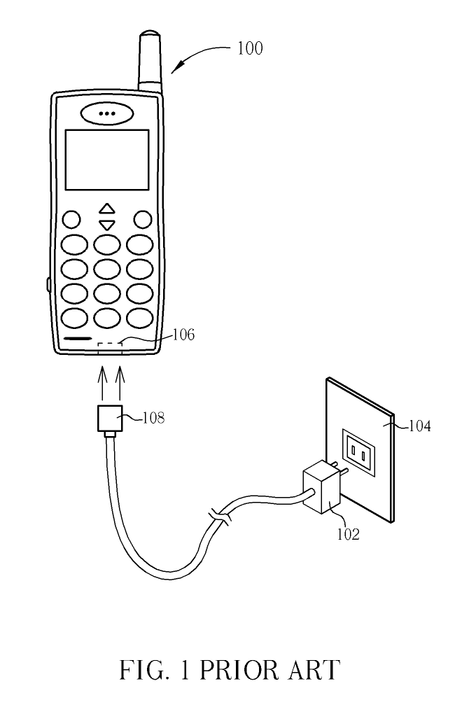

FIG. 2 illustrates a schematic diagram of a charging system for enhancing convenience according to an embodiment of the present invention.

FIG. 3 illustrates a schematic diagram of a charging system for enhancing convenience according to an embodiment of the present invention.

### DETAILED DESCRIPTION

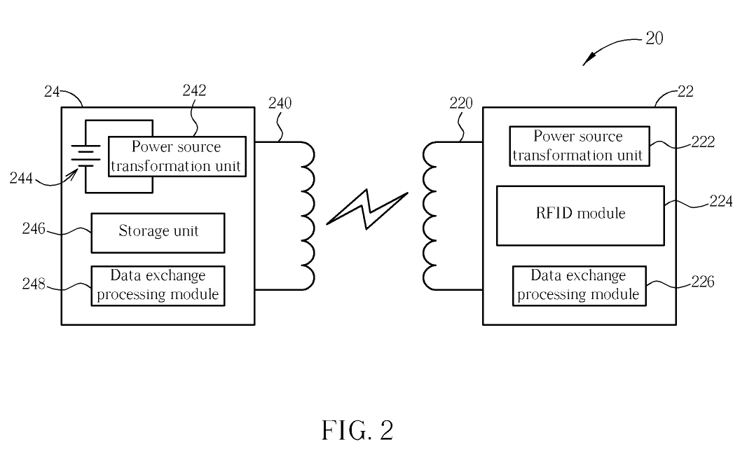

Please refer to FIG. 2. FIG. 2 illustrates a schematic diagram of a charging system 20 for enhancing convenience according to an embodiment of the present invention. The charging system 20 comprises a charging device 22 and a rechargeable device 24. The charging device 22 comprises an induction antenna 220, a power source transformation unit 222, a radio-frequency identification (RFID) module 224, and a data exchange processing module 226. The rechargeable device 24 is installed in a portable electronic device (not shown in FIG. 2), and comprises an induction antenna 240, a power source transformation unit 242, a rechargeable battery 244, a storage unit 246, and a data exchange processing module 248.

In the charging system 20, the power source transformation unit 222 of the charging device 22 transforms an AC power source (not shown in FIG. 2) into the electromagnetic wave signal and emits the electromagnetic wave signal into the air through the induction antenna 220. The power source transformation unit 242 of the rechargeable device 24 receives the electromagnetic wave signal output by the charging device 22 through the induction antenna 240 and transforms the electromagnetic wave signal into a DC power source for charging the rechargeable battery 244. The storage unit 246 is utilized for storing RFID data. The RFID module 224 of the charging device 22 reads the RFID data stored in the storage unit 246 through electromagnetic induction for identifying the portable electronic device. In addition, the data exchange processing module 226 of the charging device 22 and the data exchange processing module 248 of the rechargeable device 24 can exchange data through electromagnetic induction, like storing data (e.g. pictures or animation) into an external storage device (e.g. hard disk, memory card, or photo album) of the charging device 22.

Therefore, the charging device 22 can charge the rechargeable device 24 through electromagnetic induction without insertion of charging plugs. In this situation, after the charging device 22 works, as long as the rechargeable device 24 is placed in an electromagnetic-induction area of the charging device 22, the rechargeable battery 244 can be charged. Since the rechargeable device 24 is not charged by means of contact charging, the present invention can effectively enhance the charging convenience and avoid the durability problem because of insertion and extraction. At the same time, the charging device 22 and the rechargeable device 24 can perform RFID operations through electromagnetic induction such that the charging device 22 is capable of determining information of the style or electric quantity of the portable electronic device and exchanging data accordingly, so as to upload or download pictures, videos, audios, calendars, etc.

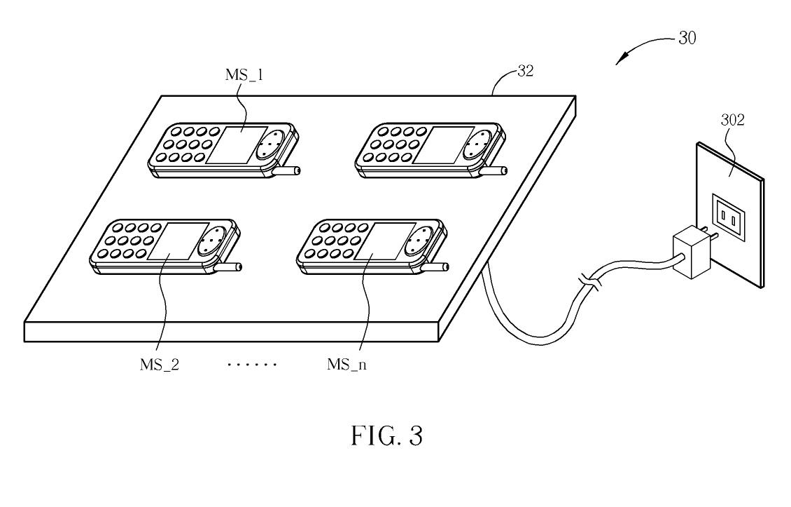

Note that, the charging system 20 illustrated in FIG. 2 is the preferred embodiment of the present invention. Those skilled in the art can modify the charging system 20 based on their requirements. For example, since the charging system 20 performs charging through electromagnetic induction, the one-to-one charging limitation can be overcome. For example, please refer to FIG. 3. FIG. 3 illustrates a schematic diagram of a charging system 30 for enhancing convenience according to an embodiment of the present invention. The charging system 30 comprises a charging device 32 and portable electronic devices MS_1˜MS_n. The operation of the charging device 32 is similar to the charging device 22 shown in FIG. 2, which is capable of transforming AC power of a power source outlet 302 into the electromagnetic wave signal for charging the electronic devices MS_1˜MS_n. Each of the portable electronic device MS_1˜MS_n comprises a rechargeable device (not shown in FIG. 3), whose structure and operation are all similar to the rechargeable device 24 shown in FIG. 2. Therefore, as long as the user places the portable electronic devices MS_1˜MS_n in the electromagnetic induction area of the charging device 32, the charging device 32 can perform charging, RFID operations, or data exchange with the portable electronic devices MS_1—MS_n through electromagnetic induction. In other words, the charging device 32 is capable of charging the portable electronic devices MS_1˜MS_n at the same time. Therefore, the present invention not only improves the durability problems caused by insertion and extraction, but also overcomes the one-to-one charging limitation.

In conclusion, the present invention performs charging, RFID operations, or data exchange through electromagnetic induction. Therefore, the present invention is capable of enhancing using convenience, avoiding the durability problems, and overcoming the one-to-one charging limitation.

Those skilled in the art will readily observe that numerous modifications and alterations of the device and method may be made while retaining the teachings of the invention.

What is claimed is:

1. A charging system for enhancing convenience comprising:
a charging device for generating an electromagnetic wave signal; and
a rechargeable device installed in a portable electronic device for receiving the electromagnetic wave signal through electromagnetic induction, so as to perform recharging.

2. The charging system of claim 1, wherein the charging device comprises:
a power source transformation unit for transforming alternating current power into the electromagnetic wave signal; and
an induction antenna coupled to the power source transformation unit for emitting the electromagnetic wave signal.

3. The charging system of claim 2, wherein the charging device further comprises a wireless RF identification module coupled to the induction antenna for identifying the portable electronic device through the induction antenna.

4. The charging system of claim 2, wherein the charging device further comprises a data exchange processing module coupled to the induction antenna for exchanging data with the portable electronic device through the induction antenna.

5. The charging system of claim 4, wherein the data exchanging processing module is further coupled to an external storage device.

6. The charging system of claim 1, wherein the rechargeable device comprises:
a rechargeable battery;
an induction antenna for receiving the electromagnetic wave signal; and
a power source transformation unit coupled between the rechargeable battery and the induction antenna for transforming the electromagnetic wave signal into direct current power for charging the rechargeable battery.

7. The charging system of claim 6, wherein the rechargeable device further comprises a storage unit coupled to the induction antenna for storing a radio-frequency identification data.

8. The charging system of claim 6, wherein the rechargeable device further comprises a data exchange processing module coupled to the induction antenna for exchanging data with the charging device through the induction antenna.

9. A charging system for enhancing convenience comprising:
a charging device for generating an electromagnetic wave signal; and
a plurality of portable electronic devices respectively comprising a rechargeable device for receiving the electromagnetic wave signal through electromagnetic induction, so as to perform recharging.

10. The charging system of claim 9, wherein the charging device comprises:
a power source transformation unit for transforming alternating current power into the electromagnetic wave signal; and
an induction antenna coupled to the power source transformation unit for emitting the electromagnetic wave signal.

11. The charging system of claim 10, wherein the charging device further comprises a radio-frequency identification module coupled to the induction antenna for identifying the plurality of portable electronic devices through the induction antenna.

12. The charging system of claim 10, wherein the charging device further comprises a data exchange processing module coupled to the induction antenna for exchanging audio, video, data, and other electronic contents with the plurality of portable electronic devices through the induction antenna.

13. The charging system of claim 12, wherein the data exchange processing module is further coupled to an external storage device.

14. The charging system of claim 9, wherein each rechargeable device comprises:
a rechargeable battery;
an induction antenna for receiving the electromagnetic wave signal; and
a power source transformation unit coupled between the rechargeable battery and the induction antenna for transforming the electromagnetic wave signal into direct current power for charging the rechargeable battery.

15. The charging system of claim 14, wherein each rechargeable device further comprises a storage unit coupled to the induction antenna for storing a radio-frequency identification data.

16. The charging system of claim 14, wherein each rechargeable device further comprises a data exchange processing module coupled to the induction antenna for exchanging data with the charging device through the induction antenna.
